(19) United States
(12) Patent Application Publication
(10) Pub. No.: US 2013/0266189 A1
(43) Pub. Date: Oct. 10, 2013

(54) METHOD FOR THE PRE-PROCESSING OF A THREE-DIMENSIONAL IMAGE OF THE SURFACE OF A TYRE USING SUCCESSIVE B-SPLINE DEFORMATIONS

(71) Applicants: Régis Vinciguerra, Clermont-Ferrand Cedex 9 (FR); Steve Bourgeois, Clermont-Ferrand Cedex 9 (FR); Alexandre Joly, Clermont-Ferrand Cedex 9 (FR)

(72) Inventors: Régis Vinciguerra, Clermont-Ferrand Cedex 9 (FR); Steve Bourgeois, Clermont-Ferrand Cedex 9 (FR); Alexandre Joly, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/881,783

(22) PCT Filed: Oct. 20, 2011
(86) PCT No.: PCT/EP11/68322

§ 371 Date: Jun. 24, 2013

(30) Foreign Application Priority Data
Oct. 27, 2010 (FR) 1058825

(51) Int. Cl. G06T 7/00

(52) U.S. Cl. CPC G06T 7/0004
USPC 382/104

(57) ABSTRACT

A method for inspecting a tyre surface involves comparison with an image of a three-dimensional (“3D”) reference surface. The method includes: extracting contours of graphic elements of an image of a 3D profile of a tyre surface to be inspected; locating characteristic points on the image of the tyre surface, and pairing the characteristic points with corresponding reference characteristic points on the image of the reference surface; associating a first reset B-spline surface with the reference surface by associating the reference characteristic points of the image of the reference surface with control points of the first reset B-spline surface; and deforming the reference surface by moving the control points of the first reset B-spline surface so as to superpose the control points on the characteristic points of the tyre surface, in accordance with the reference characteristic points of the reference surface paired with the characteristic points of the tyre surface.

The invention relates to the field of tyre manufacture. More particularly, the present invention concerns the problem of visual inspection of tyres during or at the end of the production process for the purpose of determining whether they conform to the control references established for the purpose of the use of which the said tyre will be made.

The methods employed for carrying out these processings usually consist in comparing a two- or three-dimensional image of the surface of the tyre to be inspected with a reference image in two or three dimensions of the surface of the said tyre. The general principle of these methods consists in establishing a correspondence between the image or the surface of the tyre to be inspected, and the image or the reference surface, for example by superposing them, in order to determine the moulding anomalies by analysing the differences between the two images or the two surfaces.

In the case of the tyre, the reference image of the surface may come for example from the digital data originating from the design of the tyre or, more commonly, from the digital data used to describe and to manufacture the curing mould, the said mould itself being designed to give its definitive shape to the said tyre.

The three-dimensional image of the surface of the tyre may be obtained, in a known manner, with the aid of an acquisition system capable of determining the three-dimensional relief of the tyre surface.

Matching the reference surface and the surface of the tyre to be evaluated uses methods which must be adapted to the particular case of this type of object.

Therefore, as an example, publication U.S. Pat. No. 5,715,166 describes the conversions to be made to match a reference surface with a three-dimensional image of a given object by using conversion functions such as rotations or slidings. This method is applied with good results when it is sought to match non-deformable solid objects such as metal parts, in this instance considered to be infinitely rigid. It does not apply to the tyre situation because of the deformable nature of this product.

Publication EP 1 750 089, which relates more specifically to an application designed for the inspection of tyres, proposes to divide the surface to be inspected and the reference surface into surface portions of reduced dimensions, corresponding substantially to the surface of a marking element such as a letter or a set of letters, and then sliding one onto the other, the said surface portions of the reference surface and of the surface to be inspected, so as to determine the optimum match between the contours of the reliefs of the two surface portions. After having carried out this local resetting, the two surface portions are compared with one another in order to determine, in the zone corresponding to the surface portion, the degree of conformity of the tyre to be inspected relative to a reference.

Although the algorithms described in this publication have the advantage of dispensing, to a certain degree, with the positional differences between the model and the real tyre to be evaluated, and with the differences in fitting and inflation from one casing to another, they are close to those described in publication U.S. Pat. No. 5,715,166 in that they also assimilate the surface portions with rigid elements.

Specifically, it is observed that the tyre coming out of the mould does not exactly match the negative image of the mould in which the moulding and curing operation has been carried out, because of the elastic nature of the materials that make it up. The tyre deforms as soon as it comes out of the curing press under the action of the thermal retractions of the materials when cooling. Moreover, when fitted and inflated, the reinforcing plies take their final position and the curve of equilibrium of the inflated tyre does not necessarily match the curvature of the curing mould.

Also, it is found to be necessary to make a very precise prior adjustment of the image of the reference surface and of the acquired image of the surface of the tyre to be inspected in order to match the two surfaces for the purpose of obtaining therefrom pertinent information on the conformity of the tyre resulting from the production.

The method described in publication WO2009077539 proposes, in order to achieve this objective, to make affine transformations of the reference surface, of which the coefficient is different from 1, so as to have it coincide with the surface to be inspected, which is the equivalent of carrying out a variable elastic deformation in a particular direction of the said surface, and thereby distinct from a simple variation of scale.

It is however observed that this method does not make it possible to make the adjustments necessary to the perfect superposition of the surfaces because of the fact that this method deforms the surface in only one preferred direction, while it is observed that these elastic deformations may occur in different directions when travelling over the circumference of the tyre. This simplification can then induce incorrect judgements during the comparison of the surface to be inspected with the reference surface.

The method according to the invention is designed for the inspection of a portion of the surface of a tyre by comparison with a three-dimensional reference surface, the said surfaces comprising markings in relief, and comprises the steps during which:
the three-dimensional profile of the surface to be inspected is determined,
the contours of the graphic elements are extracted,
characteristic points on the surface to be inspected are located and these points are paired with the corresponding characteristic points of the reference surface so as to create a set of couples of paired points.

This method is characterised in that:
a first reset B-spline surface is associated with the reference surface by associating the characteristic points of this surface with the control points of the said first reset B-spline surface,
the reference surface is deformed by moving the control points of the first reset B-spline surface so as to superpose them on the characteristic points of the surface to be inspected with which they are paired.

“B-spline surfaces” mean the spline surfaces developed around the works of Pierre Bézier and Paul de Casteljau, and as explained in their principles in the work of G. Demengel and J P Pouget “Modèles de Bézier, des B-splines et des NURBS” (Bézier, B-Splines and NURBS models) published by Ellipses, or else in the publication of L. Piegl and W. Tiller, The Nurbs Book 2^{nd} ed., Springer, Chap. 2-3. Also by extension, a B-spline surface in the context of the present description means all the surfaces parameterised with the aid of control points such as the NURBS (Non Uniform Rational Basis Splines) surfaces, the T-spline surfaces etc.

The use of B-spline surfaces to deform the contours of the reference image makes it possible to match the graphic elements of the surface to be inspected with the graphic elements of the reference surface for the purpose of minimising the errors of judgement when comparing by difference the surface to be inspected with the reference surface.

Preferably, to reduce the calculation time, it is advisable, prior to the extraction of the graphic contours, to flatten out the radial profile of the surface to be inspected and of the reference surface.

In order also to reduce the processing of the data originating from the means for digitising the surface to be inspected, it is also possible, prior to the extraction of the graphic contours, to transform the polar coordinates expressed relative to the rotation axis of the tyre of the image of the surface to be inspected and of the reference surface, into Cartesian coordinates.

Also to reduce the bulk of the calculation operations, during a step which precedes the extraction of the graphic contours, it is possible usefully to transform the data relating to the relief of each of the three-dimensional images to grey level so as to obtain the images in two dimensions of the surface to be inspected and of the reference surface.

In this way, the digital processings are carried out in a two-dimensional space and the calculations are reduced accordingly.

Once the first deformation of the contours of the graphic elements of the reference surface has been carried out with the aid of the first reset B-spline surface, it is possible for reset differences to subsist.

In which case, it is possible to carry out a finer reset in which the reference surface and the surface to be inspected are divided into graphic elements and
an elementary B-spline surface comprising a second set of control points is associated with each graphic element of the transformed reference surface, and
a second deformation of the contour of each graphic element of the reference surface is made by modifying the position of the second control points of the elementary B-spline surface so as to minimise the distances between the contour of the graphic element of the reference surface and the contour corresponding thereto of the graphic element of the surface to be inspected.

If positioning differences subsist, it is also possible to subdivide the said elementary B-spline surface, by increasing the number of control points, so as to associate a third set of control points with a subdivided B-spline surface that corresponds to each subdivided graphic element of the reference surface.

In order to reduce calculation times, it is possible usefully to carry out this subdivision around only the control points of the second set which influence a point of the contour of the reference surface that is incorrectly reset after the first deformation.

A third deformation of the contour of the graphic element of the reference surface is then carried out by modifying the position of the control points of the subdivided B-spline surface so as to minimise the distances between the contour of the graphic element of the reference surface and the contour of the graphic elements of the surface to be inspected.

The inspection method according to the invention then proposes to assess the conformity of the zone to be inspected by comparing the digital data describing the surface to be inspected with the digital data describing the reference surface modified with the aid of the first, of the second or of the third deformation.

The invention also relates to a device for inspecting the surface of a tyre which comprises means making it possible to determine the three-dimensional profile of the surface to be inspected, means for storing the digital data describing the reference surface, and computer calculating means capable of applying the calculation algorithms comprising the steps in which:
the three-dimensional profile of the surface to be inspected is determined,
the contours of the graphic elements are extracted,
characteristic points on the surface to be inspected are located and these points are paired with the corresponding characteristic points of the reference surface so as to create a set of couples of paired points,
a first reset B-spline surface is associated with the reference surface by associating the characteristic points of this surface with the control points of the said first reset B-spline surface,
the reference surface is deformed by moving the control points of the first reset B-spline surface so as to superpose them on the characteristic points of the surface to be inspected with which they are paired.

The object of the following description is to describe in detail the main steps of applying the method according to the invention based on the figures and explanatory diagrams 1 to 8 in which:

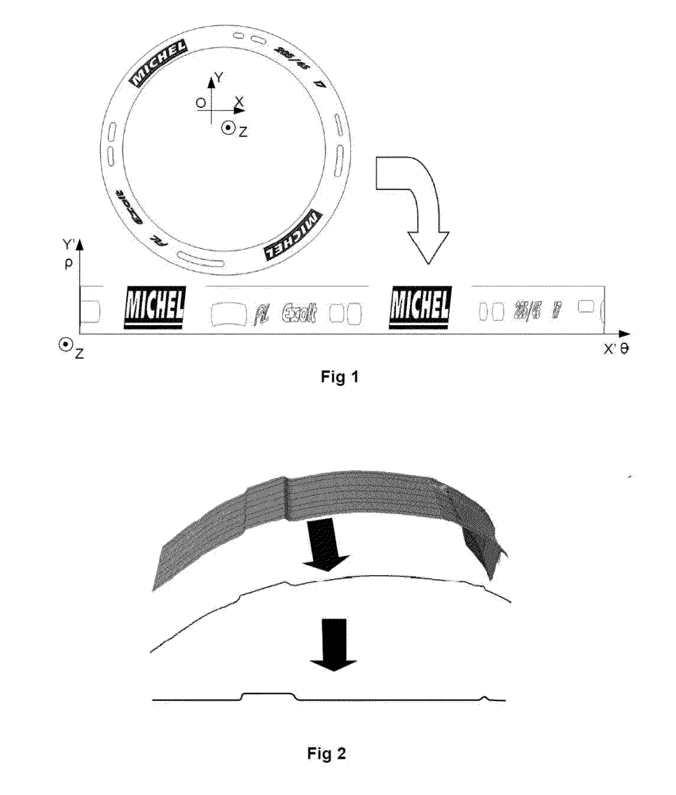

FIG. 1 represents the 2D image of the contours of the elements in relief of a reference surface and of the opened-out image of this image,

FIG. 2 represents an illustration of the steps for determining the flattened-out profile,

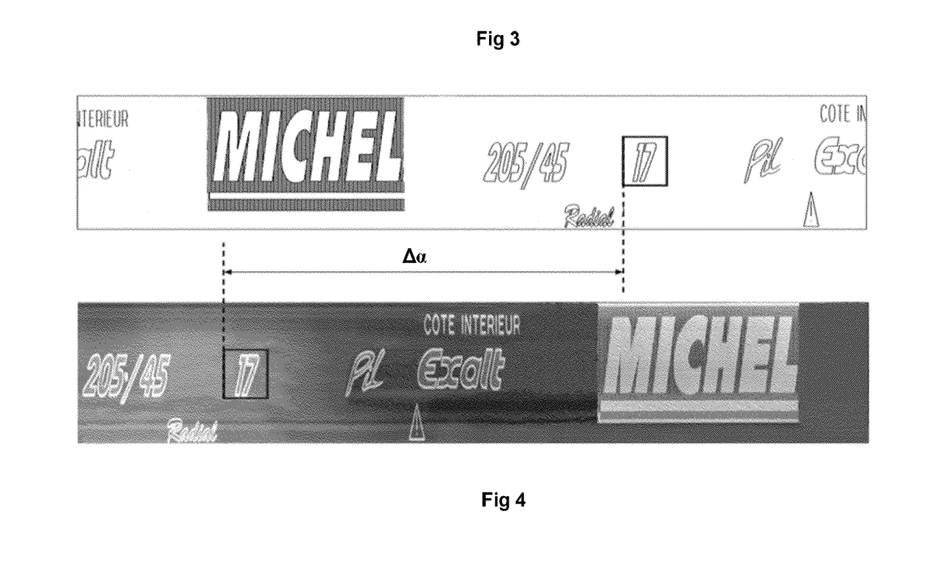

FIGS. 3 and 4 illustrate the steps of azimuth resetting,

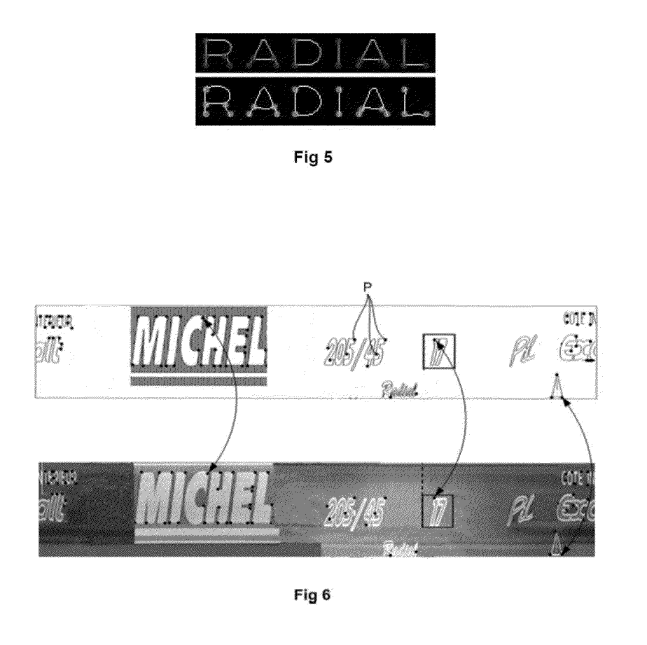

FIG. 5 illustrates the choice of characteristic points,

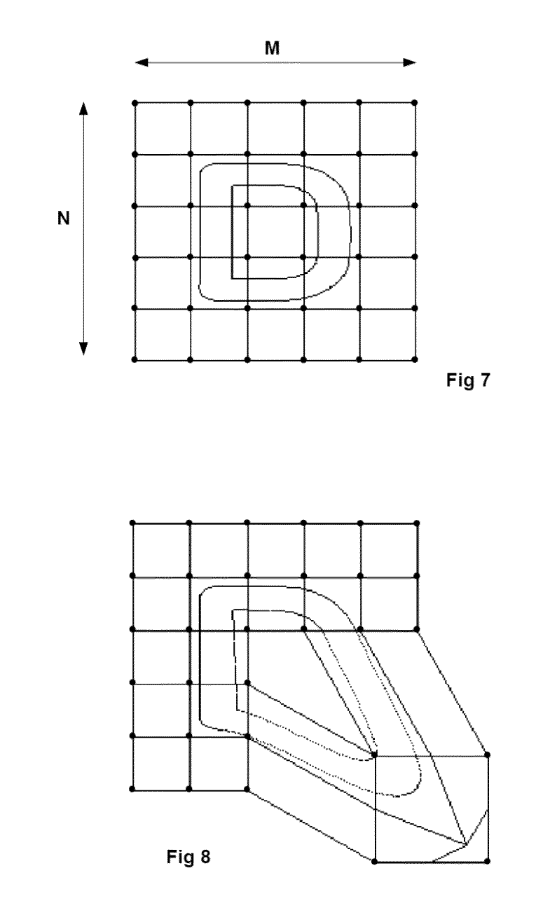

FIG. 6 illustrates the pairing of the characteristic points forming the first set of control points,

FIG. 7 illustrates an example of elementary B-spline surface and of a second set of control points,

FIG. 8 illustrates the deformation of the contours of the graphic element contained in the elementary surface by modifying the position of the control points of the second set of control points,

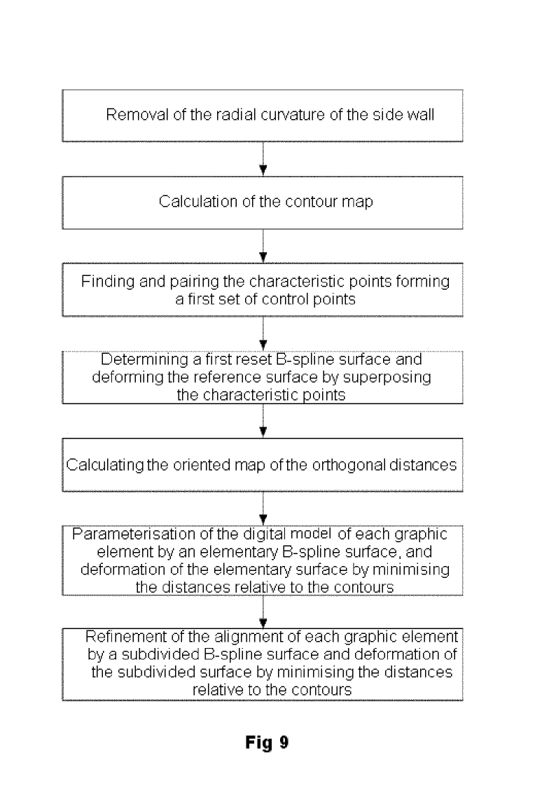

FIG. 9 is a diagram of the main steps for implementing a method according to the invention.

The inspection method according to the invention relates to the portions of the surface of a tyre that comprise markings in relief. “Markings in relief” means the elements such as figures or alphanumeric characters, sequences of characters forming words or numbers, figurative characters such as ideograms of the decorative patterns or of the drawings, of the grooves, situated on the sidewall or on the inner surface, or else of the sculpture patterns of the tread.

In a known manner, the user then seeks to obtain the data making it possible to characterise the three-dimensional surface of the surface to be inspected. In order to carry out this operation, the surface is lit with the aid of a white light or of a light with a given wavelength formed by the light originating from a laser beam, and the light reflected by the surface is captured with the aid of an acquisition means such as a matrix camera. It is also possible to use a laser triangulation, three-dimensional sensor of which the principles can be assimilated, in two dimensions, to those of a linear camera.

The tyre to be inspected is installed on a means making it possible to set it to rotate relative to the acquisition system. By making the tyre carry out a complete revolution around its rotation axis relative to the acquisition system, the digital data are obtained which, after processing by an appropriate and known calculation means, are representative of the three-dimensional coordinates of the surface to be inspected which is then materialised by a set of points in a three-dimensional space.

The exemplary embodiment of the invention described below relates more particularly to the inspection of the sidewalls of the tyre which are usually filled with markings and with graphic patterns of all kinds. However, the techniques used may, providing there is transposition, be used in an identical manner for the inspection of the inner portion or of the tread.

The surface used as a reference may originate from the three-dimensional design data of the tyre or, preferably, from the data for the design and production of the curing mould and more specifically from the data used to etch the shells used to mould the sidewalls and bearing the hollowed markings.

As has been mentioned above, it is worthwhile for an effective implementation of the method, to simplify the calculations to be made by carrying out several prior simplification steps.

It is possible for example to appropriately choose the coordinate systems in which the three-dimensional coordinates of the points of the reference surface and of the surface to be inspected will be expressed, so as to allow simple projections making it possible to reduce the number of dimensions of the space to be studied.

Also, it is arranged so that the coordinates in three dimensions x, y, z of the surfaces to be analysed are expressed in an OX, OY, OZ rectangular coordinate system in which the axis OZ is substantially indistinguishable from the rotation axis of the tyre.

It is then possible to transform the polar coordinates of type ρ, θ of the surface to be inspected and of the reference surface into Cartesian coordinates relative to the axes OX and OY, which consists in opening out the surface as illustrated in FIG. 1. For this it is sufficient to consider that the value of ρ corresponds to the value along an axis OY′ and that the value θ corresponds to the coordinate along the axis OX′. The coordinate system OXY itself being a rectangular coordinate system.

Another simplification consists in flattening out the three-dimensional surface. Accordingly, the mean profile of the curve of the surface should be determined in a radial plane. All of the points in the plane formed by the axes OZ and OX′ are projected, as illustrated in FIG. 2, which corresponds to a projection in a radial plane. The shape of the mean radial profile will be given by the shape of the cloud of points in this radial plane, from which it is possible to extract a mean curve by taking the mean of the values in a direction OZ. The surface obtained by again opening out this mean radial profile corresponds substantially to the surface of the tyre on which no relief marking would appear.

It is then sufficient, for each value of the angle θ, to subtract the value of this mean radial profile of the coordinates expressed in the plane OX′Z to obtain a flattening out of the opened-out surface determined above, and in which only the elements in relief have a value along the axis OZ.

The flattening out may also be carried out by following the profile of the surface along a determined course, for example a radial line, by detecting the localised variations of the profile signifying the relief markings made on the said surface. It is then sufficient, after having applied a filter to eliminate the abnormal variations and the slow variations associated with only the variation in curvature, to reproduce these variations on a flat surface on which only the elements in relief corresponding to the markings appear.

Also to simplify the calculations, it is possible to assign a grey-level value to the value along the axis OZ. This then gives a two-dimensional image of the surface on which the elements in relief are detached visually relative to the colour of the mean surface. The intensity of the grey level is proportional to the elevation of the point relative to the mean relief of the surface. The latter simplification can be carried out with a similar result on the flattened-out surface according to one of the methods explained above.

FIG. 3 illustrates the result of these simplifications which are more particularly adapted to the processing of the sidewall of the tyre and applied to the surface to be inspected that has been opened out, laid flat and converted into a grey-level image.

FIG. 4, for its part, represents the image opened out and laid flat of the reference surface.

It is also possible to reset the image of the reference surface relative to the image of the surface to be inspected. Accordingly, a collection of alphanumeric characters or of patterns which are present only once on the surface is predetermined as illustrated in FIGS. 3 and 4. When these characters have been located in the two images, the annular difference Δα is assessed between these two characters or series of characters and a change of coordinates is carried out on the axis OX′ (representing the angular values θ), by having the origin of these angular values passed through these characters.

Once these simplifications are complete, the map of the contours of each graphic element present on the reference surface and on the surface to be inspected is produced. The conventional Deriche algorithm is used to carry out this operation for which reference should be made to the publication Computer Vision, volume 1 pages 167-187 of April 1987 appearing under the title “Using Canny's criteria to derive a recursively implemented optimal edge detector”.

The user will then seek to define a first B-spline surface representing the reference surface by defining a first set of control points.

To do this, characteristic points associated with easily recognisable patterns of the surface to be inspected are located on the surface to be inspected. For example it will be possible to use a conventional optical character recognition method better known as OCR (Optical Character Recognition) for the purpose of identifying and locating the alphanumeric characters and associated texts that are present on the surface.

After having located the alphanumeric characters, the texts or the patterns on the image of the reference surface and on the image of the surface to be inspected, the characters, texts or patterns that are present on the two surfaces are associated.

Thus, with reference to FIG. 5, the word “RADIAL” situated close to the bead on the reference image is associated with the word “RADIAL” situated in the same region of the image to be inspected.

A set of characteristic points P present on each character, or on each pattern is determined. These points are formed, as an example, by the intersection of the branches of the skeleton lines or else by the terminal points of the said branches. The location of these points is precise as illustrated in FIG. 5 where the characteristic point associated with the bottom left corner of the L of “RADIAL” of the reference image is associated with the bottom left corner of the first L of “RADIAL” of the image to be inspected.

The characteristic points of the image of the reference surface and of the image of the surface to be inspected are then associated in twos to form couples of paired characteristic points.

The number of paired characteristic points is variable from one dimension to another and may also change between two successive analyses of one and the same tyre depending on possible anomalies that may be found on the relief markings, but also because of the successive rejections that may have been carried out at each of the steps of application of the optical character recognition method, which generates its own errors when the recognition criteria are not all fulfilled.

Ideally, the pairs of characteristic points are distributed over the whole of the surface to be inspected as illustrated in FIG. 6.

Then, a first reset B-spline surface is associated with all of the characteristic points of the reference surface while considering that these characteristic points form a first set of control points of the said reset B-spline surface. Each point of the reference surface is then parameterised as a linear combination of the position of the control points of the first reset B-spline surface.

P₁ will designate all of the control points forming a first set of control points, and p₁ will be the set of parameters defining the positions of these control points in the coordinate system defining the position of the points of the reference surface.

The contours of the reference surface are then discretised by a regular sampling into a finite set Ω₁ of points.

The position of each of these points is then defined as a linear combination of the position of the control points of the first reset B-spline surface.

This set Ω₁ of points being parameterised by the control points of the B-spline surface, Ω₁(p₁) designates the configuration taken by the points of Ω₁ for the parameter set p₁. A modification of the positions of the control points of the B-spline surface (and hence of p₁) causes a deformation of the reference surface similar to that sustained by the B-spline surface that is associated therewith. This deformation is called a B-spline deformation of Ω₁.

The next step consists in deforming the reference surface by modifying the position of the control points of the first set of control points of the reset B-spline surface, corresponding to the characteristic points of the reference surface so as to superpose them on the characteristic points of the surface to be inspected that are paired with them.

This first deformation is relatively simple to implement but requires, as has already been said above, particular attention in the choice of the control points. Specifically, it is important that the control points be sufficient in number and that they be distributed evenly over the surface to ensure a deformation making it possible to best superpose the reference surface and the surface to be inspected.

When this is not the case, it is then possible, if necessary, to carry out a finer resetting between the graphic elements of the reference surface and the graphic elements of the surface to be inspected.

This step makes it possible to more precisely adjust the shape of a graphic element of the reference surface to the exact shape of this same graphic element contained in the surface to be inspected.

First, the reference surface is divided into elementary surfaces containing one or more graphic elements. A “graphic element” in this instance means a letter, a decorative pattern or else a set of letters of small dimension.

An elementary B-spline surface is associated with each graphic element completely covering the said graphic element as illustrated in FIG. 7. This surface is parameterised by a control grid formed of N lines and of M columns defining N×M control points. The control points belong to the reference surface. In general, the lines and the columns are distributed evenly. As an example, they form grids of reduced dimensions of 4×4 or 5×5 type when the graphic element is included in an elementary surface in the shape of a square.

In the following equations, the index 2 signifies that it involves the second set of control points and the second deformation designed to carry out a fine resetting of the elementary surfaces.

Hereinafter, P₂ will mean all of the control points forming a second set of control points, and p₂ will indicate the set of parameters defining the positions of these control points in the coordinate system defining the position of the points of the reference surface.

As in the previous resetting step, the contours of the graphic element situated in the said elementary surface, in this instance illustrated in FIG. 7, the contours of the letter D are then discretised by a regular sampling into a finite set Ω₂ of points. To each of these points is added an item of information of orientation of the contour in this point.

The position of each of these oriented points is then defined as a linear combination of the position of the control points of the B-spline surface. Similarly, the orientation of each of these points is expressed according to the position of the control points of the B-spline surface.

This set Ω₂ of oriented points being parameterised by the control points of the B-spline surface, Ω₂(p₂) designates the configuration taken by the points of Ω₂ for the parameter set p₂.

The next step consists in deforming the contour of each graphic element of the reference surface by modifying the position of the control points of the second set of control points of the elementary B-spline surface so as, unlike the first deformation, to minimise the distances between the contour of the graphic element of the reference surface and the contour corresponding thereto of the graphic element of the surface to be inspected. As illustrated in FIG. 8, a modification of the positions of the control points of the B-spline surface (and hence of p₂) causes a deformation of the graphic element similar to that sustained by the B-spline surface that is associated therewith. This deformation is called the B-spline deformation of Ω₂.

To carry out this optimisation effectively, it is wise to define, for each contour of a graphic element, a map of the distances in which the values of the pixels of the image represent the distance from this pixel to the closest pixel of the contour present in the image. This method is described by H. G. Barrow, J. M. Tenenbaum, R. C. Baum & H. C. Wolf in the article “Parametric correspondence and chamfer matching; two techniques for image matching” in Proc. Int. Joint Conf. Artificial Intelligence 977, p. 659-663. The value of this optimisation algorithm lies in its simplicity.

In order to gain in precision and robustness, specific constraints can be added in the construction of the map of the distances by using distance maps oriented in given directions. The distance taken into account then corresponds to the distance from the point to the closest contour, in a given direction corresponding substantially to the direction of the segment on which this point is situated. This method is described as an example by Clark F. Olson & Daniel P Huttenlocher in the article “Target Recognition by Matching Oriented Edge Pixels” IEEE, Transactions on Image Processing, Vol 6, No. 1 Jan. 1997. This trick is used to make the obtained results more reliable by “filtering” not very pertinent contours for the precise resetting.

L₂ indicates all of the control points of the elementary B-spline surface of which the position is free, that is to say of which the position can be modified by the optimisation algorithm of the reset. F₂ indicates all of the control points of the elementary B-spline surface of which the position is fixed, that is to say of which the position cannot be modified by the optimisation algorithm of the reset.

The parameter set p₂ is then divided into a parameter set l₂ defining the position of the control points of L₂ and a parameter set f₂ defining the position of the control points of F₂. Hereinafter, the notation p₂(l₂,f₂) will be used to designate the value of the parameter set p at a given moment.

Furthermore, R₂ will indicate all of the points of Ω₂ of which the position is influenced by at least one control point belonging to L₂ (a point A of Ω₂ is influenced by a control point P_{i,j} if the coefficient associated with P_{i,j} in the linear combination defining the position of A is not zero). The notation R₂(p₂(l₂,f₂)) will be used to designate the configuration taken by the points of R₂ for a B-spline deformation of parameter p₂(l₂,f₂).

The optimisation of the positions of the points belonging to L₂ and F₂ are initialised as follows:

L₂=P₂ and F₂=ø

### Consequently: R₂=Ω₂

Furthermore, a variable counting the number of iterations of the optimisation process is initialised at 0. This will make it possible to limit the number of iterations of the optimisation process.

The optimisation of the resetting Ω₂(p₂(l₂,f₂)) consists in finding the parameter set l for which the points of Ω₂(p₂(l₂,f₂)) are projected closest to their real position in the acquisition.

In order to evaluate the current resetting Ω₂(p₂(l₂,f₂)), the following quality criterion is defined:

E(Ω₂(p₂(l₂,f₂))=E_{d}(R₂(p₂(l₂,f₂)))+λEᵣ(p₂(l₂,f₂))

where:
E_{d}(R₂(p₂(l₂,f₂))): a term for tagging to the data. It measures the mean orthogonal distance from the points of R₂(p₂(l₂,f₂)) to the closest contour corresponding to them.
Eᵣ(p₂(l₂,f₂)): a term of regularisation aiming to penalise the deformations that are not very realistic with respect to the nature of the sidewall. This term penalises the deformations having contractions/expansions that are too great or radii of curvature that are too large.
λ: a weighting factor used to adjust the influence of the term of regularisation.

With respect to the term for tagging to the data E_{d}, the resetting error of a point of R(p(l,f)) is directly obtained by looking at the value of the pixel in the same position and with the same orientation in the previously calculated distance map.

With respect to the term of regularisation Eᵣ, this is defined as follows:

$${E}_{r} ( {p}_{2} ( {l}_{2} , {f}_{2} ) ) = {\sum }_{i = 0}^{M} {( {\sum }_{j = 0}^{M} ‖ \begin{matrix}{P}_{i , j} ( {p}_{2} ( {l}_{2} , {f}_{2} ) ) - \\ {P}_{i + 1 , j} ( {p}_{2} ( {l}_{2} , {f}_{2} ) )\end{matrix} ‖ - ‖ {P}_{i , j} ( {p}_{init} ) - {P}_{i + 1 , j} ( {p}_{init} ) ‖ )}^{2} + {\sum }_{i = 0}^{M} {( {\sum }_{j = 0}^{M - 1} ‖ \begin{matrix}{P}_{i , j} ( {p}_{2} ( {l}_{2} , {f}_{2} ) ) - \\ {P}_{i , j + 1} ( {p}_{2} ( {l}_{2} , {f}_{2} ) )\end{matrix} ‖ - ‖ {P}_{i , j} ( {p}_{init} ) - {P}_{i , j + 1} ( {p}_{init} ) ‖ )}^{2} + {\sum }_{i = 0}^{N - 2} {( {\sum }_{j = 0}^{M} ‖ \begin{matrix}{P}_{i , j} ( {p}_{2} ( {l}_{2} , {f}_{2} ) ) - \\ {P}_{i + 2 , j} ( {p}_{2} ( {l}_{2} , {f}_{2} ) )\end{matrix} ‖ - ‖ {P}_{i , j} ( {p}_{init} ) - {P}_{i + 2 , j} ( {p}_{init} ) ‖ )}^{2} + {\sum }_{i = 0}^{N} {( {\sum }_{j = 0}^{M - 2} ‖ \begin{matrix}{P}_{i , j} ( {p}_{2} ( {l}_{2} , {f}_{2} ) ) - \\ {P}_{i , j + 2} ( {p}_{2} ( {l}_{2} , {f}_{2} ) )\end{matrix} ‖ - ‖ {P}_{i , j} ( {p}_{init} ) - {P}_{i , j + 2} ( {p}_{init} ) ‖ )}^{2}$$

where:
P_{i,j} is the control point associated with the line i and with the column j of the control grid of the B-spline surface
pᵢₙᵢₜ: the parameter set corresponding to the initial B-spline surface (i.e. not deformed).

Optimising the resetting of Ω₂ therefore consists in finding the parameter set l which minimises E(Ω₂,p₂(l₂,f₂)). This optimal parameter set/is estimated with the aid of a non-linear optimisation algorithm such as that of Levenberg-Marquardt of which the principles are described as an example in the publication by W. F. Press, S. A. Teukolsky, W. T. Vettering and B. P. Flannery in the volume: “Non linear Models” chapter 15.5 under the title: “Numerical Recipes in C”.

After the non-linear optimisation, the variable counting the number of iterations of the optimisation process is incremented by 1.

The iteration stops when the stop criterion is reached. For this, the user identifies, amongst the points of R₂, the set V₂ of points of which the resetting error after an iteration is greater than a fixed threshold δ. This set V₂ corresponds to all of the points of Ω₂ for which the current resetting quality is insufficient. If the set V₂ is empty or if the number of iterations of the optimisation algorithm is too high, the optimisation process is interrupted. Otherwise, the iteration process is restarted.

It may happen that the deformation p₂(l₂,f₂) does not offer the desired resetting quality and that it is then necessary to increase the number of degrees of freedom of the latter in order to allow a modelling of more complex deformations.

It is possible then to envisage a last step of fine adjustment which consists in subdividing the elementary B-spline surface deformed with the aid of the second set of control points and containing the graphic element, by increasing the number of control points so as to associate each graphic element of the reference surface originating from the second deformation with a subdivided B-spline surface formed with the aid of a third set of control points and concerning a particular detail of the contour of the graphic element.

For this, the elementary B-spline surface associated with the graphic element is subdivided with the aid for example of an algorithm of the Catmull-Clark type as described in the publication Computer-Aided design 10(6) pages 350-355 of November 1978 entitled “Recursively generated B-Splines surfaces on arbitrary topological surfaces”. This subdivision increases the number of control points without modifying the surface described. The deformation defined by this surface is therefore the same as that obtained after the previous step.

The B-spline surface associated with Ω₂ is replaced by this new subdivided B-splice surface. The points of Ω₂ are then expressed as surface points of the new subdivided B-spline surface. This means that the position/orientation of the points of Ω₂ is expressed in the form of a linear combination of the positions of new control points of the third set of control points of the subdivided B-spline surface.

To reduce the calculation times, the elementary B-spline surface is subdivided around only the control points of the second set that influence a contour point of the first set of control points of the reference surface that was incorrectly reset after the second deformation, considering that, since the influence of a control point on the B-spline surface is local, only the control points influencing at least one incorrectly reset point of Ω₂(p₂(l₂,f₂) require being optimised.

This therefore gives as many third deformations as subdivided elementary surfaces.

The sets L₂ and F₂ are therefore updated in the following manner:
L₂=all the control points influencing at least one point of V₂.
F₂=P₂\L₂

The set R₂ is also updated based on the new definition of the sets L₂ and F₂.

And the optimisation process is repeated as described in the previous paragraphs, reusing the same calculation process in which, if required, a notation is adopted followed by an index 3 in order to signify that it is a deformation of a subdivided element.

The third deformations of the subdivided surface makes it possible to achieve a virtually perfect level of superposition of the contour elements of the reference surface and of the contour elements of the surface to be inspected. What this means is that the very precise superposition of the surfaces makes it possible to reduce the differences that are still possible between the two surfaces far below the thresholds of appearance of defects that it is sought to detect.

Each of the points of the reference surface is therefore transformed a first time with the aid of the first B-spline deformation, and a second time with the aid of a second or even a third B-spline deformation corresponding to the elementary surface or to the subdivided elementary surface. The value of these successive B-spline transformations lies in the fact that the resetting obtained is achieved preferably in the zones of great deformation while avoiding the deformations that are too great in the zones that are not very disrupted.

The diagram of FIG. 9 lists the main steps of a preferred mode of implementing the invention.

Assessing the conformity of the surface to be inspected relative to the reference is not explicitly the subject of the present invention but it will be observed that the preparatory steps that consist in implementing the resetting method according to the invention and as described in the foregoing paragraphs makes it possible to make a more pertinent analysis of the differences between the surface to be inspected and the reference surface. The result of this is a considerable reduction in the number of incorrect detections, and a better appreciation of the production anomalies in the portions of the surface that do not contain reliefs.

It goes without saying that the implementation of the inspection method according to the invention is associated with the use of informatic means programmed for this purpose and capable of implementing the calculation algorithms comprising the steps in which:
the three-dimensional profile of the surface to be inspected is determined,
the contours of the graphic elements are extracted,
characteristic points on the surface to be inspected are located and these points are paired with the corresponding characteristic points of the reference surface so as to create a set of couples of paired points,
a B-spline surface is associated with the reference surface by associating the characteristic points of this surface with the control points of the said B-spline surface,
the reference surface is deformed by moving the control points of the B-spline surface so as to superpose them on the characteristic points of the surface to be inspected with which they are paired.

1-10. (canceled)

11. A method for inspecting a surface of a tyre by comparison with an image of a three-dimensional reference surface, the reference surface and the surface of the tyre including markings in relief, the method comprising steps of:
obtaining an image of a three-dimensional profile of a tyre surface to be inspected;
extracting, from the image of the tyre surface to be inspected, contours of graphic elements;
locating characteristic points on the image of the tyre surface to be inspected, and pairing the characteristic points with corresponding reference characteristic points of the image of the reference surface so as to create a set of paired points;
associating a first reset B-spline surface with the reference surface by associating the reference characteristic points of the reference surface with control points of the first reset B-spline surface; and
deforming the image of the reference surface by moving the control points of the first reset B-spline surface associated with the reference characteristic points of the reference surface so as to superpose the control points of the first reset B-spline surface on the characteristic points of the image of the tyre surface to be inspected paired therewith.

12. The method according to claim 11, wherein, prior to the extracting step, a radial profile of the tyre surface to be inspected and a radial profile of the reference surface are laid out flat.

13. The method according to claim 11, wherein, prior to the extracting step, for the image of the tyre surface to be inspected and the image of the reference surface, polar coordinates expressed relative to a tyre rotational axis and polar coordinates of the reference surface are transformed into Cartesian coordinates.

14. The method according to claim 12, wherein, prior to the extracting step, relief data relating to the image of the tyre surface to be inspected and the image of the reference surface is transformed to grey level data so as to produce a two-dimensional image of the tyre surface to be inspected and a two-dimensional image of the reference surface.

15. The method according to claim 11, further comprising:
after the deforming step, dividing the image of the reference surface and the image of the tyre surface to be inspected into graphic elements;
for each graphic element of the image of the reference surface deformed in the deforming step, associating an elementary B-spline surface that includes a set of second control points to the graphic element; and
for each graphic element of the image of the reference surface deformed in the deforming step, carrying out a second deformation of a contour of the graphic element by modifying a position of the second control points of the elementary B-spline surface so as to minimize distances between the contour of the graphic element and a corresponding contour of a graphic element of the image of the tyre surface to be inspected.

16. The method according to claim 15, wherein, after the second deformation, the elementary B-spline surface is subdivided by increasing a number of control points, such that a set of third control points is associated with a subdivided B-spline surface.

17. The method according to claim 16, wherein the elementary B-spline surface is subdivided only around control points of the set of second control points having an influence on a point of a contour of a graphic element of the image of the reference surface that is incorrectly reset after the second deformation using the set of second control points.

18. The method according to claim 16, further comprising:
carrying out a third deformation of the contour of the graphic element of the image of the reference surface by modifying positions of points of a set of third control points of a subdivided B-spline surface so as to minimize distances between the contour of the graphic element of the image of the reference surface and a contour of a graphic element of the image of the tyre surface to be inspected.

19. The method according to claim 11, wherein a conformity of a zone of the tyre surface to be inspected is assessed by comparing digital data describing the image of the tyre surface to be inspected with digital data describing a modified reference surface after the image of the reference surface is deformed in the deforming step.

20. An inspection apparatus for inspecting a surface of a tyre, the apparatus comprising:
a memory storing digital data describing a reference surface of a tyre;
a processor programmed to calculate algorithms of a program of a tyre inspection method, including:
extracting, from an image of a three-dimensional profile of a tyre surface to be inspected, contours of graphic elements of the tyre surface to be inspected,
locating characteristic points on the image of the tyre surface to be inspected, and pairing the characteristic points with corresponding reference characteristic points of the image of the reference surface so as to create a set of paired points,
associating a B-spline surface with the reference surface by associating the reference characteristic points of the reference surface with control points of the B-spline surface, and
deforming the image of the reference surface by moving the control points of the B-spline surface associated with the reference characteristic points of the reference surface so as to superpose the control points of the B-spline surface on the characteristic points of the image of the tyre surface to be inspected paired therewith.
